(19) United States
(12) Patent Application Publication
(10) Pub. No.: US 2008/0138085 A1
(43) Pub. Date: Jun. 12, 2008

(54) Illumination with optical communication method

(75) Inventors: Shar-Ming Lin, Taipei (TW); Ming-Yang Chern, Piscataway, NJ (US); Ching-Pao Chou, Taipei (TW); Chung-Nung Huang, Taipei (TW); Chih-Chang Huang, Taipei (TW)

Correspondence Address: Troxell Law Office Pllc, 5205 Leesburg Pike, Suite 1404, Falls Church, VA, 22041, US

(73) Assignee: Formolight Technologies Inc.

(21) Appl. No.: 11/819,706

(22) Filed: Jun. 28, 2007

(30) Foreign Application Priority Data
Jun. 29, 2006 (TW) 095123562

(51) Int. Cl. H04B 10/00

(52) U.S. Cl. 398/172

(57) ABSTRACT

The present invention provides an illumination with optical communication method that includes the following steps: a), establishing a signal source; b), encoding and transmitting of signal; c), actuating an LED to emit light; d), detecting light variation; e), analyzing, decoding and signal regeneration, which enables the recovery of original data for use, saving or playing back thereof. Basing on such a method, a light illumination system with optical communication capability can be established.

### BACKGROUND OF THE INVENTION

(a) Field of the Invention

The present invention relates to an illumination with optical communication method, particularly to the one that uses the fast lighting characteristic of an LED (Light-Emitting Diode), whereby a transmitter transmits encoded message data awaiting transmission, which then appears as the light of rapid variation emitted by an LED illumination apparatus. A receiver, that uses a sensor to detect the light of varying intensity emitted by the LED illumination apparatus, analyzes the digital waveform contained therein, whereupon a signal processor decodes the digital waveform to extract the transmitted message data. Accordingly, such a method provides the present invention with both illumination and communication capabilities, which is applicable to a variety of illumination devices adopted for optical communication.

(b) Description of the Prior Art

The prior art method of using optical fibers to transmit signals has existed for many years, and the essential condition for such a method is the need to set up an optical-fiber circuit to enable transmitting the data signals. In regard to the transmission media, the optical-fiber method to transmit optical signals is a “wired communication” method, and the optical-fiber circuit incurs the cost of material and installation. Although its transmission distance is relatively long, it is subject to space limitations as the installation for optical fibers/cables requests. Furthermore, the optical fibers are comparatively expensive. Thus, in quite some situations the approach does not always stand for an ideal and complete solution.

### SUMMARY OF THE INVENTION

A primary objective of the present invention is to provide an illumination with optical communication method that uses an LED illumination apparatus to transmit encoded message data awaiting transmission, which then appears as the light of rapid varying intensity emitted by this transmitter. While a receiver uses a sensor to detect the light emitted by the LED illumination apparatus and analyzes a digital waveform contained therein, whereupon a signal processor decodes the digital waveform to extract the transmitted message data, thereby offering the optical communication capability to the illumination apparatus, which increases practicability and convenience of use thereof.

In order to achieve the aforementioned objective, the optical communication method of the present invention comprises the following steps: a), establishing a signal source: message data awaiting transmission presented in the form of a digital electric signal is established as a signal source; b), encoding and transmitting of signal: a signal modulator encodes and converts the digital electric signal awaiting transmission into an on and off control signal, and then the modulated on and off control signal is transmitted to a control circuit of an LED illumination apparatus; c), actuating an LED to emit light: the encoded and modulated on and off control signal actuates the LED illumination apparatus, which emits a modulated light; d), detecting light variation: a sensor is used to detect brightness variation in the modulated light emitted by the LED illumination apparatus, thereby obtaining a digital waveform contained therein; e), analyzing, decoding and signal regeneration: a signal processor performs analysis and decodes the digital waveform detected by the sensor, which enables the recovery of original data for use, saving or playing back thereof. Basing on such a method, a light illumination system with the communication capability can be established.

To enable further understanding of the said objectives and technological methods of the invention herein, brief description of the drawings is provided below followed by detailed description of the preferred embodiments.

### BRIEF DESCRIPTION OF THE DRAWINGS

FIG. 1 shows a schematic view depicting the procedural steps according to the present invention.

FIG. 2 shows a schematic view depicting a block diagram according to the present invention.

FIGS. 3-8 show schematic views depicting the LED lighting modes according to the present invention.

### DETAILED DESCRIPTION OF THE PREFERRED EMBODIMENTS

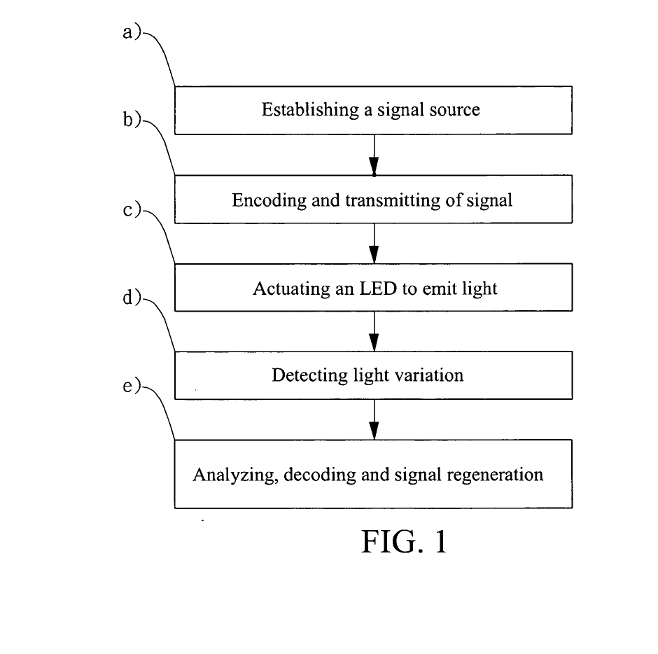

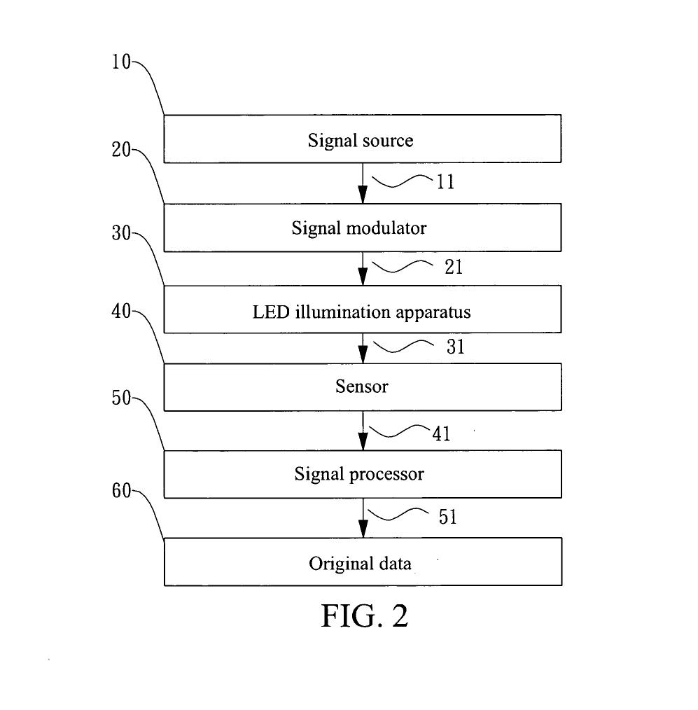

Referring to FIGS. 1 and 2, which show an optical communication method of the present invention, comprising the following steps:

a). Establishing a signal source 1: A signal source 10 is first established for signal transmission of a message data awaiting transmission 11 presented in the form of a digital electric signal (the message data awaiting transmission 11 can be a sound file, an image file, a document file or a command).

b). Encoding and transmitting of signal 2: A signal modulator 20 receives the message data awaiting transmission 11 presented in the form of a digital electric signal, whereupon the message data 11 are converted into an on and off control signals 21, and then the modulated on and off control signals 21 are transmitted to an LED (light-emitting diode) control circuit, thereby enabling the modulated on and off control signals 21 to actuate lighting up an LED illumination apparatus 30.

c). Actuating an LED to emit light 3: The modulated on and off control signals 21 actuate the LED illumination apparatus 30, thereby causing the LED illumination apparatus 30 to emit a modulated light 31.

d). Detecting light variation 4: A sensor 40 is used to detect brightness variation in the modulated light 31 emitted by the LED illumination apparatus 30, and obtains a digital waveform 41 contained therein.

e). Analyzing, decoding and signal regeneration 5: A signal processor 50 performs analysis and decoding of the digital waveform 41 obtained by the sensor 40, thereby achieving the employable message data 51 enabling the recovery of original data for use, saving or playing back thereof (wherein, the original message regenerated after the analysis and decoding using the signal processor 50 can be further used, saved or played back through a corresponding transmission circuit).

Accordingly, the aforementioned steps constitute the optical communication method of the present invention. Referring again to FIGS. 1 and 2, the present invention is characterized in that it uses the fast lighting characteristic of the LED illumination apparatus 30, and utilizes the signal modulator 20 to encode data within the emitted light 31 of the LED illumination apparatus 30, whereafter the sensor 40 is used to detect amount of energy, brightness or other detectable variations in the light 31 emitted by the LED illumination apparatus 30 to obtain the digital waveform 41. Finally, original data 60 are obtained after the analyzing and decoding of the digital waveform 41 to become the employable message data 51. The transmitted data need not be categorized as they can be originated from images, documents, texts entered via a keyboard, or sound. As long as they can be presented as digital electric signals and transmitted into the signal modulator 20 for encoding to form the on and off control signals 21 that actuate the LED illumination apparatus 30, whereupon the sensor 40 is able to detect the modulated digital waveform 41, and the signal processor 50 then enables the analysis and decoding of the modulated digital waveform 41 to regenerate the original data 60 finally, which can be saved, analyzed, or further processed.

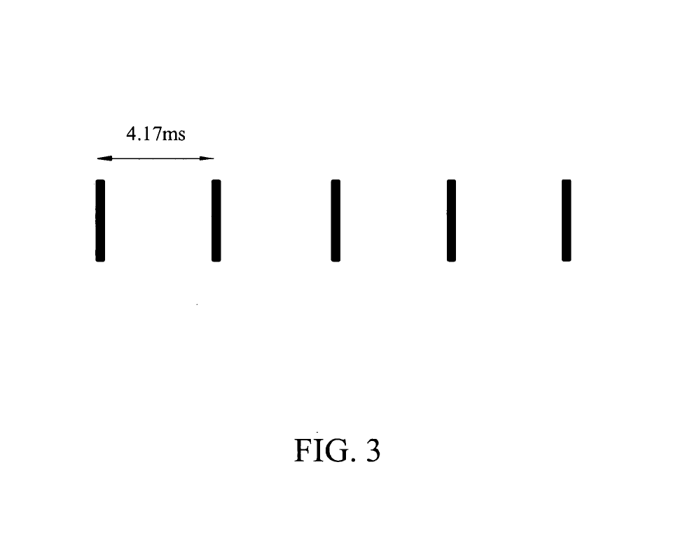

Referring to FIG. 3 related to the present invention, it is known from LED on and off lighting method that the human vision can not tell if the light is flashing when the LED scanning frequency is higher than that of human visual perception. Normally the human visual system can perceive the light flashing up to a scanning frequency of 24 Hz (Hertz). When the scanning frequency of the LED is increased to 240 Hz, the light emitted by the LED is seen as a continuous, steady light.

Each scanning period of the LED is further segmented into many equal fragments or time units, for instance, 64, 256, or even more units. In general, when controlling LED brightness, the more lighting units are within each period, the brighter the LED is seen. That is, the “total energy” within each period serves to determine the brightness of LED. Yet the LED brightness observed is not affected by where the LED lighting units are positioned within a scanning period, which means that lighting units within a scanning period can be assembled in many ways and still produce the same brightness.

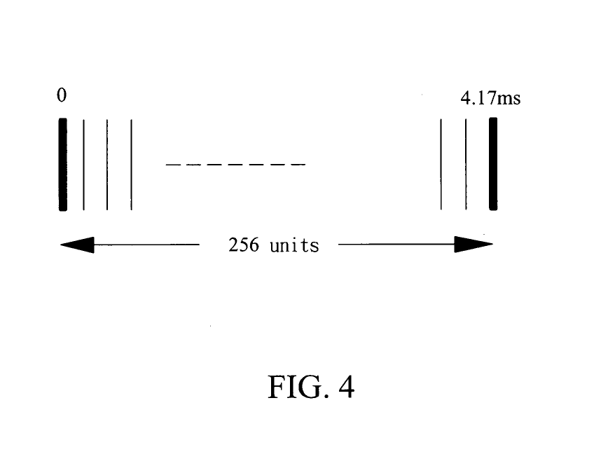

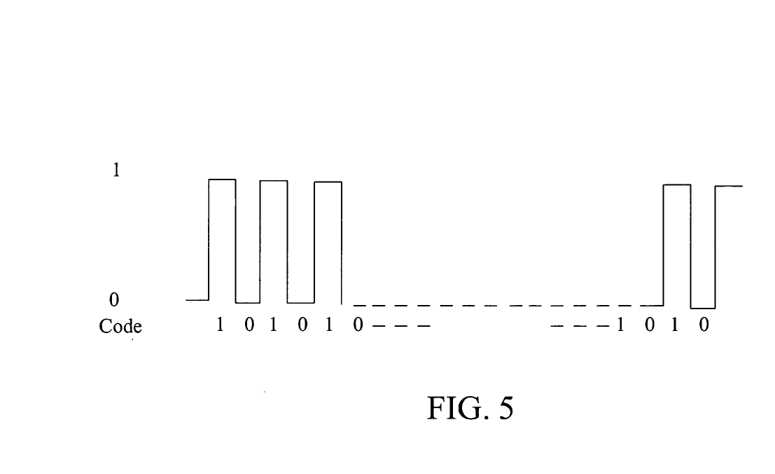

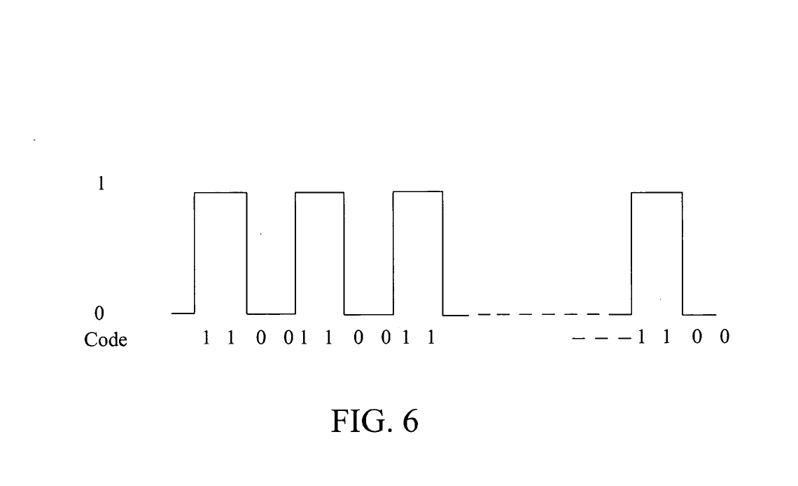

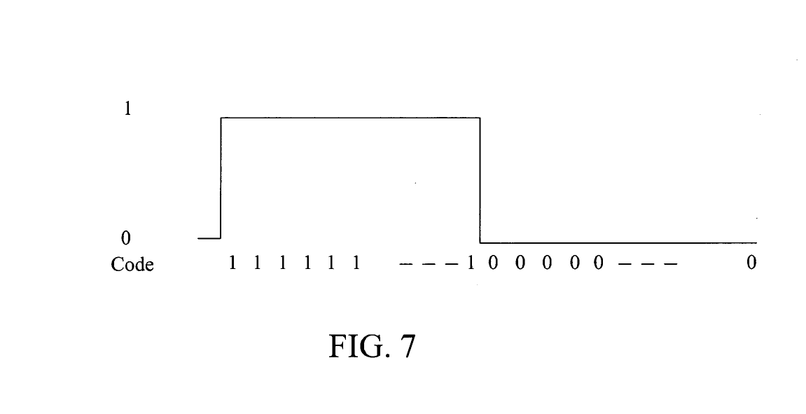

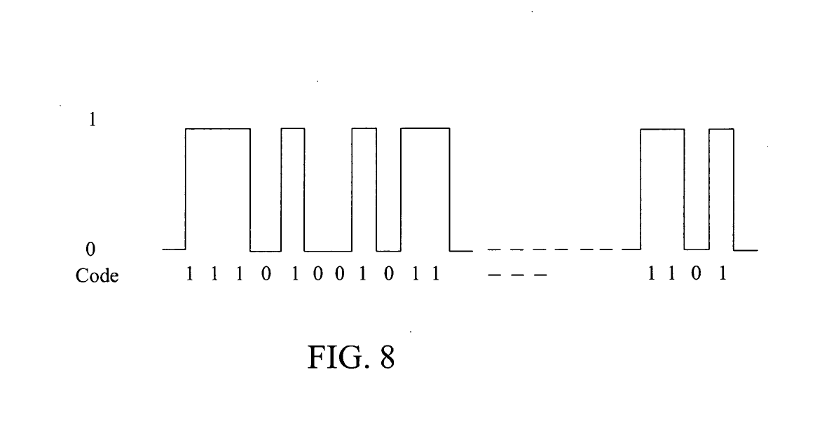

The number of time units within a LED scanning period can be different according to display needs, data format and circuit design. Referring to FIG. 4, using the grey-level of 256 as an example, which implies that each period of LED lighting is segmented into 256 equal time fragments, and each small on and off fragment is independently controlled. As the LED brightness is digitally controlled, the encoding for ‘on’ can be “1”, and “0” for ‘off’. Thus the LED showing identical brightness level would have encoded with an identical number of “1”s and “0”s, while the sequencing need not be identical. That is, different sequencing does not affect the brightness perceived. Given the brightness level 128, there are different ways of lighting the LED as the waveforms depicted in FIGS. 5, 6 and 7 (wherein, the 0/1 coding indicates that the LED in each time fragment is on or off, that is, 1 for ‘on’, 0 for ‘off’). Though the encodings depicted in FIGS. 5, 6 and 7 are different, the brightness perceived would be identical. Given a meaningful message for communication, encoding of the message produces a specific code that directs the LED to display, resulting in the waveform depicted in FIG. 8, without affecting its brightness displayed. Since the LED scanning frequency can be designed substantially higher than that of human visual perception, the digitized information can be assembled and displayed through the LED within its scanning periods without concerning the effect of illumination. Finally, the sensor 40 is used to detect variation in the LED lighting, with the waveforms saved and decoded, thereby enabling the original message to be regenerated.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An optical communication method, comprising the following steps:
a), establishing a signal source: a signal source is first established for signal transmission of message data awaiting transmission presented in the form of a digital electric signal;
b), encoding and transmitting of signal: a signal modulator receives the message data awaiting transmission presented in the form of a digital electric signal, and the message data are converted into an on and off control signals, then the modulated on and off control signals are transmitted to an LED (Light-Emitting Diode) control circuit, thereby enabling the modulated on and off control signals to actuate an LED illumination apparatus;
c), actuating an LED to emit light: the modulated on and off control signals actuate the LED illumination apparatus, which then emits a modulated light;
d), detecting light variation: a sensor is used to detect the modulated light emitted by the LED illumination apparatus, thereby obtaining a digital waveform contained therein;
e), Analyzing, decoding and signal regeneration: a signal processor performs the analysis and decoding of the digital waveform obtained by the sensor, thereby enabling the recovery of original data for use, saving or playing back thereof.

2. The optical communication method according to claim 1, wherein the message data are of a sound file.

3. The optical communication method according to claim 1, wherein the message data are of an image file.

4. The optical communication method according to claim 1, wherein the message data are of a document file.

5. The optical communication method according to claim 1, wherein the message data are of a section of commands.

6. The optical communication method according to claim 1, wherein the original message regenerated after the analysis and decoding using the signal processor is further used, saved or played back through a corresponding transmission.
